(19) United States
(12) Patent Application Publication
(10) Pub. No.: US 2005/0012988 A1
(43) Pub. Date: Jan. 20, 2005

(54) Semiconductor optical amplifier and optical amplifier module

(76) Inventors: Seung-Woo Kim, Seoul (KR); Seong-Taek Hwang, Pyeongtaek-si (KR); Jeong-Seok Lee, Anyang-si (KR)

Correspondence Address: CHA & REITER, LLC, 210 ROUTE 4 EAST STE 103, PARAMUS, NJ, 07652, US

(21) Appl. No.: 10/810,252

(22) Filed: Mar. 26, 2004

(30) Foreign Application Priority Data
Jul. 18, 2003 (KR) 2003-49343

(51) Int. Cl. H01S 3/00

(52) U.S. Cl. 359/344

(57) ABSTRACT

A semiconductor optical amplifier for amplifying an input optical signal is disclosed. The optical amplifier module includes a plurality of the semiconductor optical amplifiers, and the semiconductor optical amplifier includes a substrate, a first clad layer deposited on the substrate, an active layer deposited on the first clad layer having a plurality of sections with different band gaps arranged in a longitudinal direction thereof, and a second clad layer deposited on the active layer.

### CLAIM OF PRIORITY

This application claims priority to an application entitled “SEMICONDUCTOR OPTICAL AMPLIFIER AND OPTICAL AMPLIFIER MODULE,” filed in the Korean Intellectual Property Office on Jul. 18, 2003 and assigned Serial No. 2003-49343, the contents of which are hereby incorporated by reference.

### BACKGROUND OF THE INVENTION

1. Field of the Invention

The present invention relates to an optical amplifier element, and more particularly to a semiconductor optical amplifier having low noise figure and high saturation output power.

2. Description of the Related Art

Generally, optical amplifiers are used for amplifying an input signal and increasing the transmission distance of a transmittable optical signal such that errors generated in long-distance transmission of the optical signal can be minimized. The optical amplifiers have operational characteristics such as gain exhibiting an amplification level of the optical signal, noise figure, saturation output power, etc.

The optical amplifiers are divided into fiber optical amplifiers like Erbium doped fiber amplifiers and semiconductor optical amplifiers. The Erbium doped fiber amplifier are widely used as they exhibit excellent characteristics, such as high gain, low noise figure, and high saturation output power. However, the Erbium doped fiber amplifier is expensive and bulky compared to other amplifiers. In contrast, the semiconductor optical amplifier is relatively cheap and small, and able to amplify a broad band of wavelength.

FIGS. 1 and 2 depict a conventional semiconductor optical amplifier. As shown, the conventional semiconductor optical amplifier comprises a substrate 110, an active layer 120 deposited on the substrate 110, and a clad layer 130 deposited on the active layer 120. In operation, it amplifies an optical signal inputted into the active layer 120.

The substrate 110 is made of n-InP and has a refractivity lower than that of the active layer 120 deposited thereon. Thus, the substrate 110 serves as a clad layer against the active layer 120.

FIG. 3 is a graph illustrating the variation of a band gap along a longitudinal direction of the active layer 120 of the conventional semiconductor optical amplifier shown in FIG. 2. As shown, the active layer 120 of the semiconductor optical amplifier is configured such that the band gap of the active layer 120 is uniform along the longitudinal direction of the semiconductor optical amplifier. The active layer 120 determines the band of the wavelength of an optical signal to be amplified according to the band gap of a material in the active layer 120, and it may be made of a material such as InGaAsP so that the band gap is uniform along the longitudinal direction of the active layer 120. The clad layer 130 is deposited on the active layer 120 and is made of a material such as P-InP.

In case that driving current is applied to the semiconductor optical amplifier during an initial state that the signal light is not inputted into the semiconductor optical amplifier, the active layer 120 outputs spontaneous emission light. Here, the central wavelength of the outputted spontaneous emission light is determined by the band gap characteristics of the active layer 120.

In order to lower the noise figure in the amplified optical signal and improve the gain saturation of the amplified optical signal in the conventional semiconductor optical amplifier, it is necessary to increase the band gap of the active layer so that the central wavelength of the spontaneous emission light outputted from the active layer is shorter than the wavelength of the optical signal to be amplified. However, this approach has a drawback in that a difference between the central wavelength of the spontaneous emission light outputted from the active layer and the wavelength of the optical signal to be amplified is increased. This difference reduces the amplification gain of the optical signal and causes an extreme fluctuation of the gain according to the wavelength of the optical signal to be amplified. SUMMARY OF THE INVENTION

Therefore, the present invention has been made in view of the above problems and provides additional advantages, by providing a semiconductor optical amplifier having low noise figure, high saturation output power, and high amplification gain of an optical signal to be amplified.

In accordance with one aspect of the present invention, a semiconductor optical amplifier for amplifying an input optical signal includes: a substrate; a first clad layer deposited on the substrate; an active layer deposited on the first clad layer and having a plurality of sections with different band gaps arranged in a longitudinal direction thereof, and a second clad layer deposited on the active layer.

In accordance with another aspect of the present invention, there is provided an optical amplifier module for amplifying an optical signal comprising: a plurality of first to N'th semiconductor optical amplifiers, connected in series, and having active layers with different band gaps, wherein a distribution of the band gaps of the active layers is formed in a concave shape so that the band gaps of the first and N'th semiconductor optical amplifiers are higher than the band gaps of the second to the (N-1)'th semiconductor optical amplifiers located between the first and N'th semiconductor optical amplifiers.

### BRIEF DESCRIPTION OF THE DRAWINGS

The above features and other advantages of the present invention will be more clearly understood from the following detailed description taken in conjunction with the accompanying drawings, in which:

FIG. 1 is a schematic view of a conventional semiconductor optical amplifier;

FIG. 2 is a sectional view of the conventional semiconductor optical amplifier shown in FIG. 1;

FIG. 3 is a graph illustrating the variation of a band gap along a longitudinal direction of an active layer of the conventional semiconductor optical amplifier shown in FIG. 2;

FIG. 4 is a schematic view of an optical amplifier module, in which a plurality of semiconductor optical amplifiers each having active layers with different band gaps connected in series, in accordance with a first embodiment of the present invention;

FIG. 5 is a graph illustrating relationship of noise figures between the wavelength of an optical signal inputted into the semiconductor optical amplifier to be amplified and the central wavelength of spontaneous emission light outputted from the semiconductor optical amplifier;

FIG. 6 is a graph illustrating the relationship of the saturation output powers between the wavelength of an optical signal inputted into the semiconductor optical amplifier to be amplified and the central wavelength of spontaneous emission light outputted from the semiconductor optical amplifier;

FIG. 7 is a sectional view of a semiconductor optical amplifier including an active layer provided with a plurality of sections in accordance with a second embodiment of the present invention;

FIG. 8 is a graph illustrating the distribution of the band gaps of the active layer of the semiconductor optical amplifier shown in FIG. 7;

FIG. 9 is a sectional view of a semiconductor optical amplifier in accordance with a third embodiment of the present invention;

FIG. 10 is a graph illustrating one example of the distribution of the band gaps of an active layer of the semiconductor optical amplifier shown in FIG. 9; and

FIG. 11 is a graph illustrating another example of the distribution of the band gaps of the active layer of the semiconductor optical amplifier shown in FIG. 9.

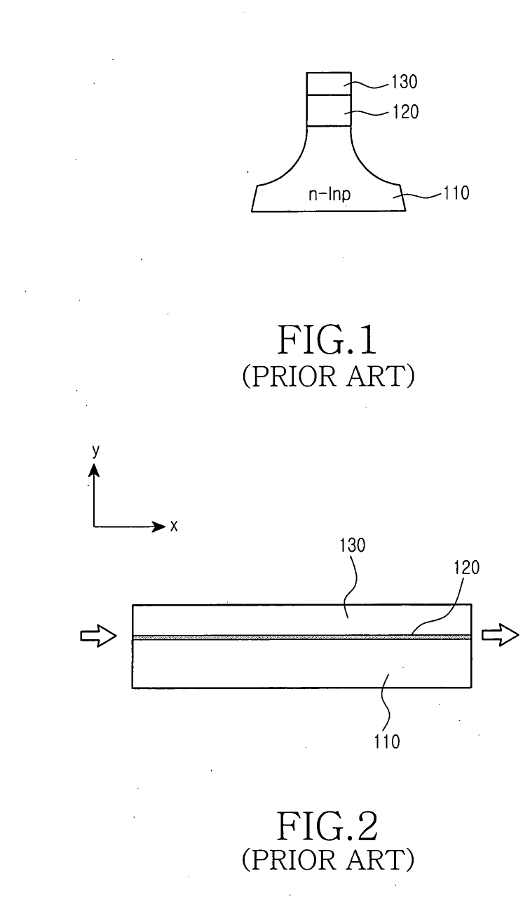

### DETAILED DESCRIPTION OF THE PREFERRED EMBODIMENTS

Now, preferred embodiments of the present invention will be described in detail with reference to the annexed drawings. For the purposes of clarity and simplicity, a detailed description of known functions and configurations incorporated herein will be omitted as it may make the subject matter of the present invention unclear.

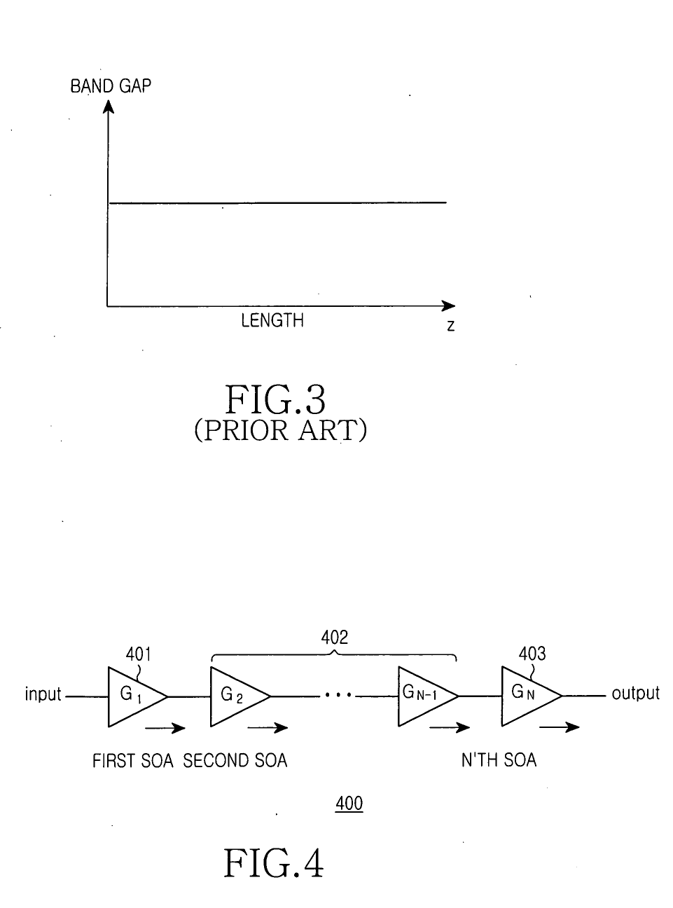

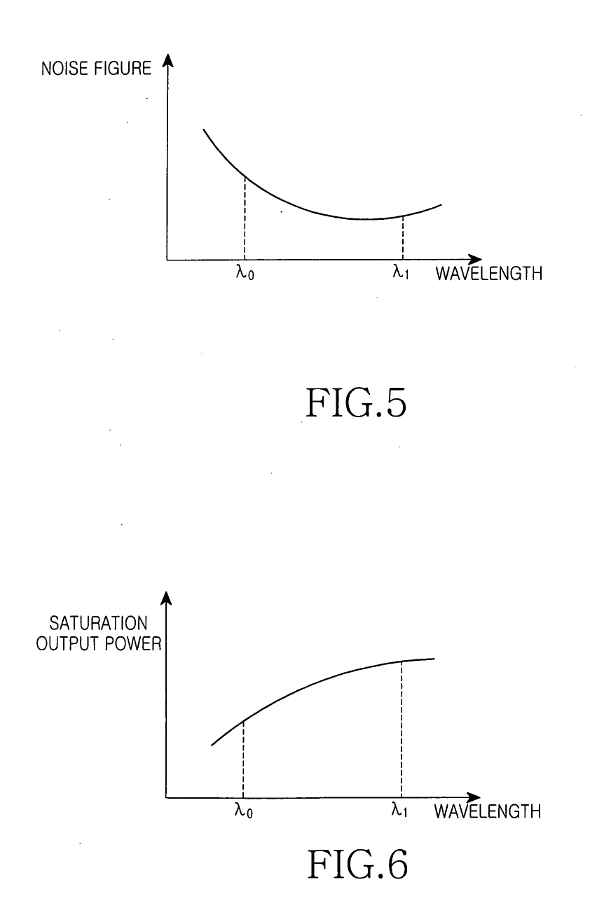

FIG. 4 is a schematic view of an optical amplifier module in accordance with a first embodiment of the present invention. As shown, a plurality of semiconductor optical amplifiers having active layers respectively with different band gaps is connected in series. FIG. 5 is a graph illustrating the relationship of the noise figures between the wavelength of an optical signal inputted into the semiconductor optical amplifier for amplification and the central wavelength of spontaneous emission light outputted from the semiconductor optical amplifier. FIG. 6 is a graph illustrating the relationship of the saturation output powers between the wavelength of an optical signal inputted into the semiconductor optical amplifier for amplification and the central wavelength of spontaneous emission light outputted from the semiconductor optical amplifier.

With references to FIGS. 4 to 6, the optical amplifier module 400 according to the first embodiment of the present invention includes a first semiconductor optical amplifier 401, and an N'th semiconductor optical amplifier 403, and second to (N-1)'th semiconductor optical amplifiers 402 connected in series between the first semiconductor optical amplifier 401 and the N'th semiconductor optical amplifier 403. Each of the amplifiers 401, 402 and 403 includes an active layer made of a material having a band gap different from each other.

Hereinafter, the ratio of a signal-to-noise ratio of an optical signal inputted into an input terminal of the active element to a signal-to-noise ratio of an amplified optical signal outputted from an output terminal of the active element is referred to as a “noise figure”.

The total noise figure of the optical amplifier module 400 comprising the semiconductor optical modules 401, 402 and 403 connected in series as shown in FIG. 4 is represented by below Equation 1.

$${NF}_{total} = {NF}_{1} + \frac{{NF}_{2}}{{G}_{1}} + \frac{{NF}_{3}}{{G}_{1} {G}_{2}} + … + \frac{{NF}_{N}}{{G}_{1} {G}_{2} … {G}_{N - 1}} + \\ \frac{1}{{G}_{1} {G}_{2} … {G}_{N}} \qquad [ Equation 1 ]$$

In above Equation 1, NF represents a noise figure, NFₜₒₜₐₗ represents a total noise figure of the optical amplifier module 400, NF_{N} represents a noise figure of the N'th semiconductor optical amplifier 403, and NF₁ represents a noise figure of the first semiconductor optical amplifier 401. G₁ represents a gain of the first semiconductor optical amplifier 401, and G_{N} represents a gain of the N'th semiconductor optical amplifier 403.

With reference to Equation 1, the total noise figure (NFₜₒₜₐₗ) of the optical amplifier module 400 is determined mainly by the noise figure (NF₁) of the first semiconductor optical amplifier 401, into which an optical signal to be amplified is initially inputted. With reference to FIG. 5, in case that the central wavelength of spontaneous emission light outputted from the semiconductor optical amplifier is shorter than the wavelength of the optical signal to be amplified, the amplified optical signal has a low noise figure.

In the embodiment, the first semiconductor optical amplifier 401 is made of a material having a high band gap so that the central wavelength of spontaneous emission light outputted from the first semiconductor optical amplifier 401 is shorter than the wavelength of the optical signal to be amplified, thus reducing the total noise figure of the optical amplifier module 400.

Gain saturation refers to a phenomenon, in which the optical signal inputted into the optical amplifier module 400 is amplified to an excessive level exceeding a desired level, such that the gain of the optical signal amplified by the optical amplifier module 400 cannot be uniformly maintained.

The above-described gain saturation is generated mainly by the N'th semiconductor optical amplifier 403 for outputting the amplified optical signal. With reference to FIG. 6, in case that the central wavelength of spontaneous emission light generated from the N'th semiconductor optical amplifier 403 is shorter than the wavelength of the optical signal to be amplified, the amplified optical signal has a high saturation output power, thus improving the above gain saturation.

Thus, the gain saturation can be reduced by the active layer of the N'th semiconductor optical amplifier 403 to have a band gap higher than that of each of the second to (N-1)'th semiconductor optical amplifiers 402, thus maintaining the gain of the amplified optical signal and increasing the saturation output power.

As a result, in the optical amplifier module 400 in accordance with the first embodiment of the present invention, each of the active layers of the first semiconductor optical amplifier 401 into which the optical signal to be amplified is inputted, and the N'th semiconductor optical amplifier 403, from which the amplified optical signal is outputted, has a band gap higher than those of the active layers of the second to (N-1)'th semiconductor optical amplifiers 402, so that each of the active layers of the first semiconductor optical amplifier 401 and the N'th semiconductor optical amplifier 403 outputs light having a central wavelength shorter than the wavelength of each of the optical signals, thus lowering the noise figure of the amplified optical signal and improving the saturation output power.

In order to save the gain loss of the amplifier optical signal generated due to the difference between the central wavelengths of the spontaneous emission light outputted from the first semiconductor optical amplifier 401 and the N'th semiconductor optical amplifier 403 and the wavelength of the optical signal to be amplified, the active layer of each of the second to (N-1)'th semiconductor optical amplifiers 402 is made of a material having a band gap lower than that of each of the active layers of the first and the N'th semiconductor optical amplifiers 401 and 403, so that the wavelengths of the spontaneous emission light outputted from the second to the (N-1)'th semiconductor optical amplifiers 402 located between the first and the N'th semiconductor optical amplifiers 401 and 403 are maximally close to the wavelength of the optical signal to be amplified.

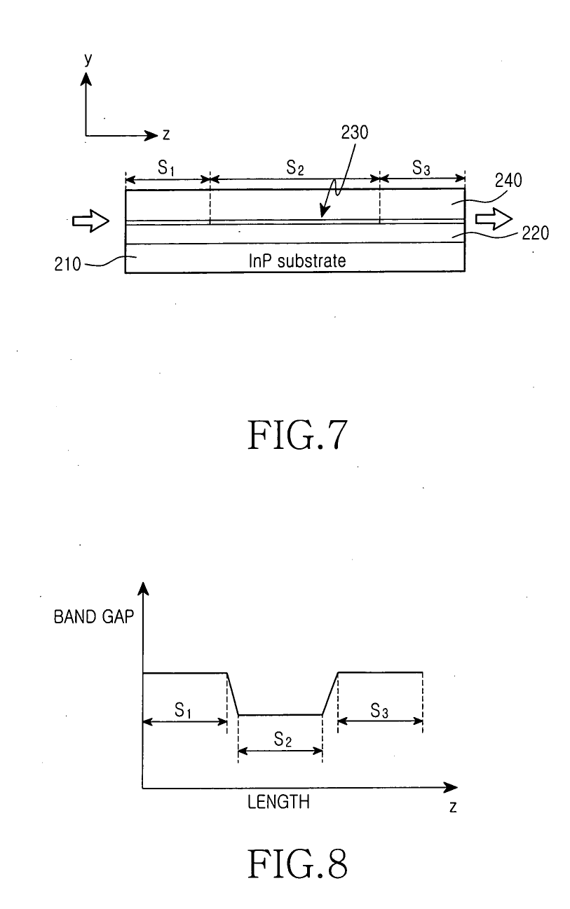

FIG. 7 is a sectional view of a semiconductor optical amplifier having an active layer provided with a plurality of sections in accordance with a second embodiment of the present invention. As shown, the semiconductor optical amplifier in accordance with the second embodiment of the present invention includes a substrate 210, a first clad layer 220 deposited on the substrate 210, an active layer 230 deposited on the first clad layer 220, and a second clad layer 240 deposited on the active layer 230.

FIG. 8 is a graph illustrating the distribution of the band gaps of the active layer of the semiconductor optical amplifier shown in FIG. 7. As shown, the active layer 230 includes a plurality of sections S₁, S₂ and S₃ having different band gaps arranged along a longitudinal direction. Since the second section S₂ has a band gap lower than the band gaps of the first and third sections S₁ and S₃ respectively formed at input and output terminals of the active layer 230, the active layer 230 has the distribution of the band gaps formed in a concave shape.

In case that driving current is applied to the semiconductor optical amplifier during an initial state and an optical signal to be amplified is not inputted into the semiconductor optical amplifier, the active layer 230 outputs a spontaneous emission light. Here, the central wavelength of the outputted spontaneous emission light is determined by the band gap characteristics of the active layer 230 material. Thus, as shown in FIG. 7, the first and third sections S₁ and S₃ can lower the noise figure of the optical signal amplified by the semiconductor optical amplifier and improve the saturation output power respectively, the second section S₂ plays a role of improving the gain of the optical signal.

Accordingly, the semiconductor optical amplifier in accordance with the second embodiment of the present invention includes the active layer 230 having the plural sections S₁, S₂ and S₃ with different band gaps, thereby improving the gain of the amplified optical signal, increasing the saturation output power, and lowering the noise figure of the optical signal amplified by the semiconductor optical amplifier.

In order to lower the noise figure of the semiconductor optical amplifier in accordance with the second embodiment of the present invention, the first section S₁ has a length longer than that of the third section S₃. On the other hand, in order to improve the saturation output power, the third section S₃ has a length longer than that of the first section S₁. That is, the semiconductor optical amplifier in accordance with the second embodiment of the present invention comprises the active layer 230 including the plural sections S₁, S₂ and S₃, of which lengths or band gaps are selectively adjusted as occasion demands, thus obtaining desired characteristics.

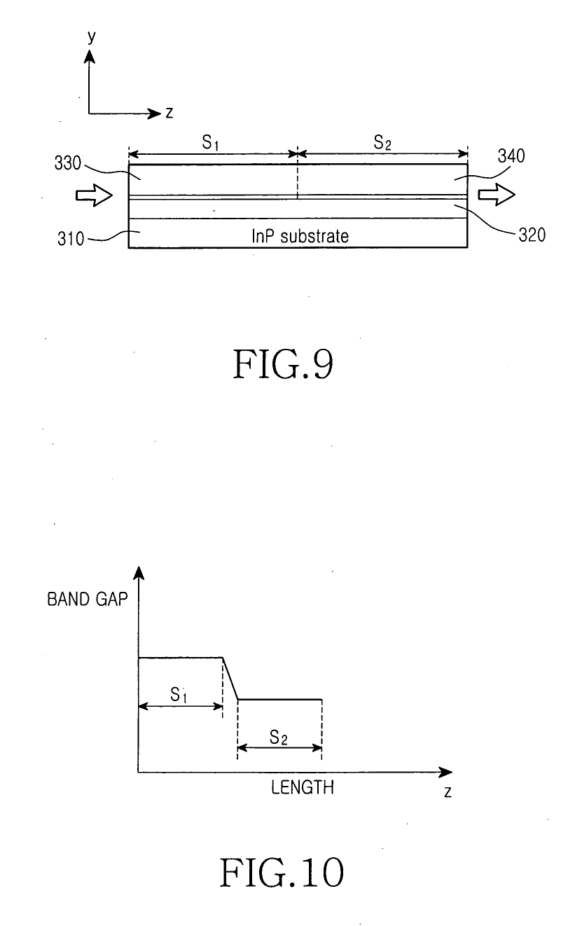

FIG. 9 is a sectional view of a semiconductor optical amplifier in accordance with a third embodiment of the present invention. FIG. 10 is a graph illustrating one example of the distribution of the band gaps of an active layer of the semiconductor optical amplifier shown in FIG. 9.

With reference to FIGS. 9 and 10, the semiconductor optical amplifier in accordance with the third embodiment of the present invention includes a substrate 310, a first clad layer 320 deposited on the substrate 310, an active layer 330, deposited on the first clad layer 320 and having a plurality of sections S₁ and S₂ with different band gaps arranged along a longitudinal direction (z), and a second clad layer 340 deposited on the active layer 330.

The substrate 310 is made of a material such as InP. The active layer 330 may be deposited directly on the upper surface of the substrate 310, thus maybe used as a substitute for the first clad layer 320.

The active layer 330 includes the first section S₁, into which an optical signal is inputted, and the second section S₂ having a band gap lower than that of the first section S₁, from which an amplified optical signal is outputted. With reference to FIG. 10, the band gap of the first section S₁ is higher than the band gap of the second section S₂. That is, the semiconductor optical amplifier in accordance with the third embodiment of the present invention comprises the active layer 330 in which the band gap of the first section S₁ is higher than the band gap of the second section S₂, thereby minimizing the noise figure of the amplified optical signal and uniformly maintaining the gain of the amplified optical signal.

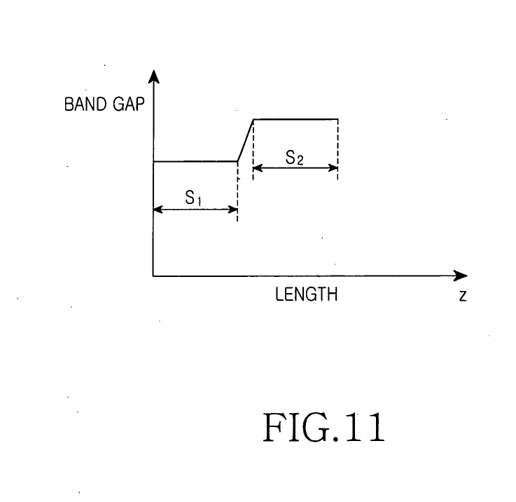

FIG. 11 is a graph illustrating another example of the distribution of the band gaps of the active layer of the semiconductor optical amplifier shown in FIG. 9. Note that the distribution of the band gaps shown in FIG. 11 is contrary to the distribution of the band gaps shown in FIG. 10. That is, the semiconductor optical amplifier in accordance with the third embodiment of the present invention comprises the active layer 330 in which the band gap of the second section S₂ is higher than the band gap of the first section S₁, thereby improving the saturation output power of the amplified optical signal and uniformly maintaining the gain of the amplified optical signal.

As apparent from the above description, the present invention provides a semiconductor optical amplifier comprising an active layer including a plurality sections having different band gaps, so that a distribution of the band gaps is optimized as occasion demands, thereby producing a lower noise figure of an amplified optical signal, a high amplification gain, and a high saturation output power of the amplified optical signal. Further, the semiconductor optical amplifier of the present invention suppresses the variation of gain according to the wavelength of an optical signal to be amplified.

Although embodiments of the present invention have been described in detail, those skilled in the art will appreciate that various modifications, additions, and substitutions to the specific elements are possible, without departing from the scope and spirit of the invention as disclosed in the accompanying claims.

1. A semiconductor optical amplifier for amplifying an input optical signal, comprising:
a substrate;
a first clad layer deposited on the substrate;
an active layer deposited on the first clad layer and having a plurality of sections with different band gaps arranged in a longitudinal direction thereof; and
a second clad layer deposited on the active layer.

2. The semiconductor optical amplifier as set forth in claim 1, wherein the active layer includes:
a first section for receiving the input optical signal; and
a second section having a band gap lower than that the first section for outputting an amplified optical signal.

3. The semiconductor optical amplifier as set forth in claim 1, wherein the active layer includes:
a first section for receiving an input optical signal; and
a second section having a band gap higher than that the first section for outputting an amplified optical signal.

4. The semiconductor optical amplifier as set forth in claim 1, wherein the active layer includes:
first and third sections respectively formed at input and output terminals of the active layer; and
a second section, located between the first and third sections, having a band gap lower than those the first and third sections.

5. The semiconductor optical amplifier as set forth in claim 4, wherein the length of the first section of the active layer is substantially longer than that the third section of the active layer.

6. The semiconductor optical amplifier as set forth in claim 4, wherein the length of the third section of the active layer is substantially longer than that the first section of the active layer.

7. The semiconductor optical amplifier as set forth in claim 1, wherein the active layer includes:
a plurality of first to N'th sections, connected in series, respectively including active layers having different band gaps,
wherein a distribution of band gaps of the active layers is formed in a concave shape so that the band gaps of the first and N'th sections are higher than the band gaps of the second to the (N-1)'th sections located between the first and N'th sections.

8. An optical amplifier module for amplifying an optical signal comprising:
a plurality of first to N'th semiconductor optical amplifiers, connected in series, respectively including active layers having different band gaps,
wherein a distribution of band gaps of the active layers is formed in a concave shape so that the band gaps of the first and N'th semiconductor optical amplifiers are higher than the band gaps of the second to the (N-1)'th semiconductor optical amplifiers located between the first and N'th semiconductor optical amplifiers.

9. The optical amplifier module as set forth in claim 8, wherein the active layer of the first semiconductor optical amplifier is made of a material having a band gap higher than the active layers of the second to (N-1)'th semiconductor optical amplifiers so as to prevent the increase of a noise figure.

10. The optical amplifier module as set forth in claim 8, wherein the active layer of the N'th semiconductor optical amplifier is made of a material having a band gap higher than the active layers of the second to (N-1)'th semiconductor optical amplifiers so as to prevent the generation of gain saturation in an amplified optical signal.
